(19) United States
(12) Patent Application Publication
(10) Pub. No.: US 2002/0058892 A1
(43) Pub. Date: May 16, 2002

(54) MASSAGE APPARATUS

(76) Inventor: JAMES V. YOUNG, UNIVERSITY CITY, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/176,866

(22) Filed: Oct. 22, 1998

(51) Int. Cl. A61H 1/00

(52) U.S. Cl. 601/96; 601/7

(57) ABSTRACT

A massage apparatus which provides a unique combination of mechanical oscillation (vibration) and suction to help break up the fat clusters and stretch fiber tissue by combining massage and strong localized suction to raise the skin and bring encapsulated fluids to the surface. The massage apparatus is designed to combine localized suction to raise the skin and contain fluids of a body part while simultaneously generating a high frequency vibration to maximize fluid flow and elongation of skin fibrous tissue to increase the flexibility and elasticity of the skin.

### CROSS-REFERENCE TO RELATED APPLICATIONS

### STATEMENT REGARDING FEDERALLY SPONSORED RESEARCH OR DEVELOPMENT

Not Applicable.

### BACKGROUND OF THE INVENTION

This invention relates to a massage apparatus for massaging the human body. While the invention is described with particular reference to that application, those skilled in the art will recognize the wider applicability of the invented principles disclosed hereinafter.

Massage apparatus and techniques employed by various types of massage machines are well known in the art. For example, U.S. Pat. No. 4,098,226 ('226), U.S. Pat. No. 4,102,334 ('334) and U.S. Pat. No. 4,757,806 ('806) all disclose apparatus designed to produce percussive directional stroking, generally for medical purposes such as to loosen and mobilize, in selected directions, bronchial secretions or other congested materials in humans or animals, to improve blood circulation, and to relax muscles, for example.

Other various massage techniques also are known, which generally involve subjecting the patient to pressure, and/or displacements, and/or pinchings. In particular, it is known that cellulite formations can be controlled by body massage. Various types of equipment have been proposed previously to facilitate a masseur's work. It also has been found that a massage technique, sometimes referred to as “rolled palpation massaging” can be used for the treatment of cutaneous and cellulite in dermalogic zones. This technique involves subjecting the patient to continuous action during which the masseuse must effect, simultaneously, not only a localized pinching, but also a progressive displacement of the pinch zone so as to provide a “roll” while at the same time exerting pressure. A device for providing roll palpitation is disclosed, for example, U.S. Pat. No. 4,729,368 ('368). In general, the device described in the '368 patent, involves a use of a roller structure and a vacuum source. The vacuum source draws the skin up between the rollers and the rollers apply force to the skin as it is drawn upwardly and held between the rollers by the vacuum source.

While all of these devices work well for their intended purpose, they either are cumbersome in application, and/or have a complex mechanical structure for example, as described in the '368 patent, or do not provide the kind of treatment that is effective for proper treatment of fat clusters and stretching the fibrous tissue. The invention described hereinafter combines mechanical oscillation, vibration and suction in a new manner, the combination of which acts in a superior way to break up fat clusters and stretch fibrous tissues by means of a combined oscillatory or vibratory massage and strong localized suction. The massage action of the invention raises the skin and brings encapsulated fluids to the surface. This physical combination stretches or elongates fibrous bans and increases circulation to the target area. The result is improved skin toning, improved elasticity and, by moving the fibers and fluids, it helps change the shape of fat compartments in the human body. The technique is non-evasive, and helps reduce dimpling and “orange-peel” textures appearance of the skin typical with cellulite formations.

### BRIEF SUMMARY OF THE INVENTION

One of the objects of the invention is to provide an improved massage therapy apparatus.

Another object of this invention is to provide a massage apparatus that combines mechanical oscillation or vibration and suction to help break up fat clusters and stretch fibrous tissue.

Another object of this invention is to provide massage apparatus which provides both a pressure and suction during massage therapy.

Yet another object of this invention to provide a massage device which is selectively operable to provide a force combination of mechanical oscillation and suction.

Another object to this invention is to provide a compact massage apparatus having simplified construction.

Other objects of the invention will be apparent to those skilled in the art in light of the following description and accompanying drawings.

In accordance with this invention, generally stated, a massage apparatus for massaging a human body, for example, includes a housing containing a motor. A drive cable is operatively connected to the motor, the drive cable having a massage head attached to it, enabling the motor to drive the massage head. The motor imports mechanical oscillations to the massage head. An applicator is mounted to the massage head and transfers mechanical oscillations to the body. The applicator head is specifically designed to provide a cavity, which permits skin to be drawing inwardly of the cavity during device operation. A vacuum pump is associated with the housing and is connected to the applicator to impart at least a partial vacuum in the applicator.

A method of treating the human body to break up fat clusters and stretch fibrous tissue is provided which applies a vibratory force and a suction force simultaneously to the body, the suction force drawing and stretching fibrous tissue and the vibratory force acting on the raised tissue.

### BRIEF DESCRIPTION OF THE SEVERAL VIEWS OF THE DRAWINGS

In the drawings, FIG. 1 is a view in side elevation of one illustrative body of massage apparatus of the present invention;

FIG. 2 is a bottom plan view thereof;

FIG. 3 is a top plan view thereof;

FIG. 4 is an end view of the device shown in FIG. 1;

FIG. 5 is a plan view of a first illustrative applicator used in conjunction with the apparatus of FIG. 1;

FIG. 6 is a sectional view taken along the lines 6-6 of FIG. 5;

FIG. 7 is a plan view of a second illustrative applicator by an application with the apparatus of FIG. 1;

FIG. 8 is a sectional view taken along line 8-8 of FIG. 7, but rotated 180° with respect to FIG. 7;

FIG. 9 is a diagrammatic view of the vacuum system employable with the apparatus of FIG. 1; and

FIG. 10 is a diagrammatic sectional view illustrating the placement of the certain mechanical components of the massage apparatus shown in FIG. 1.

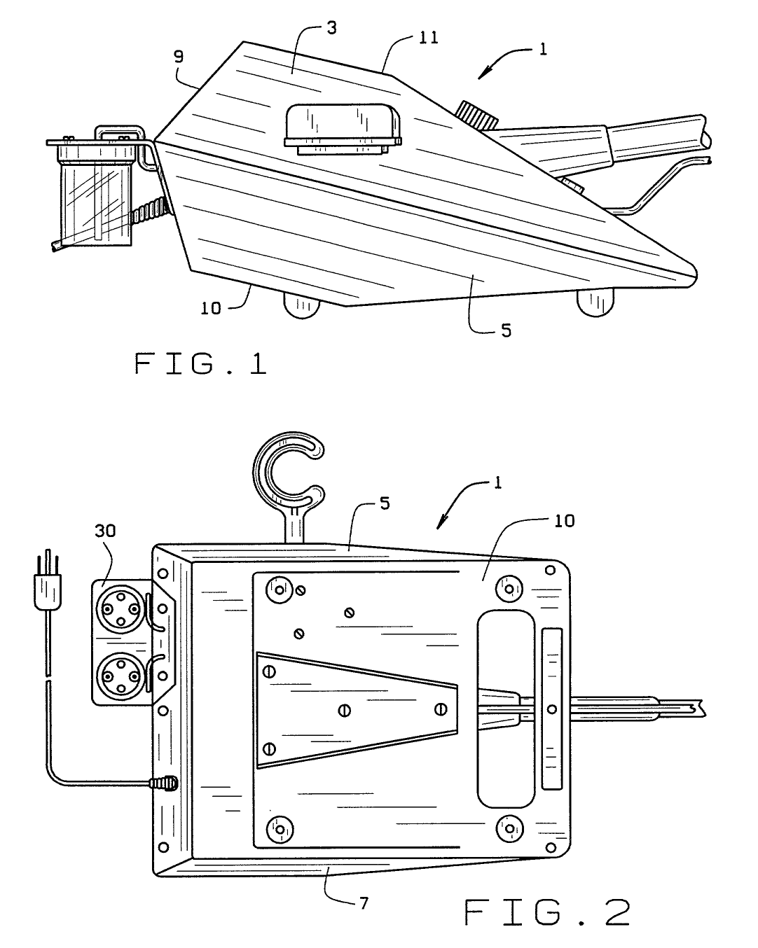

Corresponding reference numerals are used throughout the several figures of the drawings.

### DETAILED DESCRIPTION OF THE INVENTION

Referring now to the drawings, reference numeral 1 indicates one illustrative embodiment of massage apparatus of the present invention. The apparatus 1 includes a housing 3 which contains and protects certain mechanical components of the apparatus 1, as later described. The housing 3 includes a first side wall 5, a second side wall 7, a back 9, a bottom wall 10 and a top wall 11. In the embodiment illustrated, the housing 3 has a two piece, cam shell design silhouette construction which facilities construction of the housing 3 and the placement of components within the housing. Other housing 3 design silhouettes are compatible with the broader aspects of the invention.

The housing 3 has a hook structure 13 associated with it. The hook 13 is intended to retain a massage head 15 in a conventional way. Other structures for holding the massage head 15 may be employed, if desired.

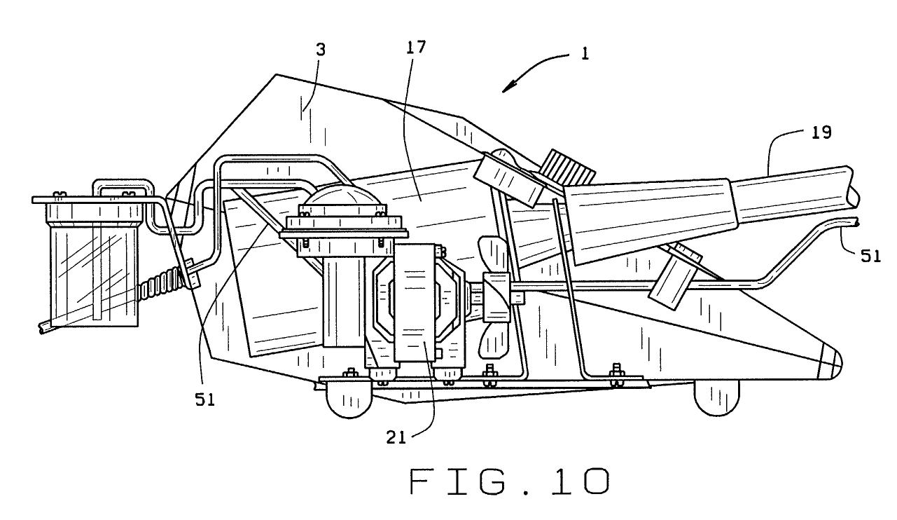

Referring now to FIG. 10, an electric motor 17 is mounted within the housing 3. Mounting is accomplished in any convenient way. The motor 17 preferably is a variable speed motor, in that the speed of rotation of the motor may be altered at will by a user. Such motors 17 may be selected from a group including conventional DC motors, switch reluctance motors, electronically controlled motors, or a controlled induction motors. All such motor types are compatible with the broader aspects of the invention, it being preferred only that the motor 17 be of a variable speed design. The motor 17 drives a transmission line 19. The transmission line 19 in turn is operatively connected to the massage head 15. The particular operation of the motor 17, transmission line 19 and massage head 15 is described in the above referenced U.S. Pat. Nos. 4,102,334, 4,098,266 and 4,757,806, the disclosures of which are incorporated herein by reference, and is not repeated here for sake of brevity.

A vacuum pump 21 also is mounted in the housing 3. Vacuum pump 21 has a suction line 23 and a discharge line 24 respectively connected to its suction side 25 and its discharge side 26.

The housing 3 also has a mounting bracket 30 attached to it, along the back wall 9. In the embodiment illustrated, the bracket 30 is sized to accept a pair of collection vial filters 33 and 34. The vials or filters 33 and 34 are mounted to the bracket 30 in any convenient way. Conventional preformed mating screw tops and vial structures work well, for example. Other attachment techniques are compatible with the broader aspect of my invention.

Any one of a variety of applicators 40 are attached to the massage head 15. Two illustrative embodiments of massage heads 40 are shown in FIGS. 5-8. Commonly, the applicator 40 are attached to the head 15 by a conventional threaded mounting structure. Other mounting arrangements will be apparent to those skilled in the art.

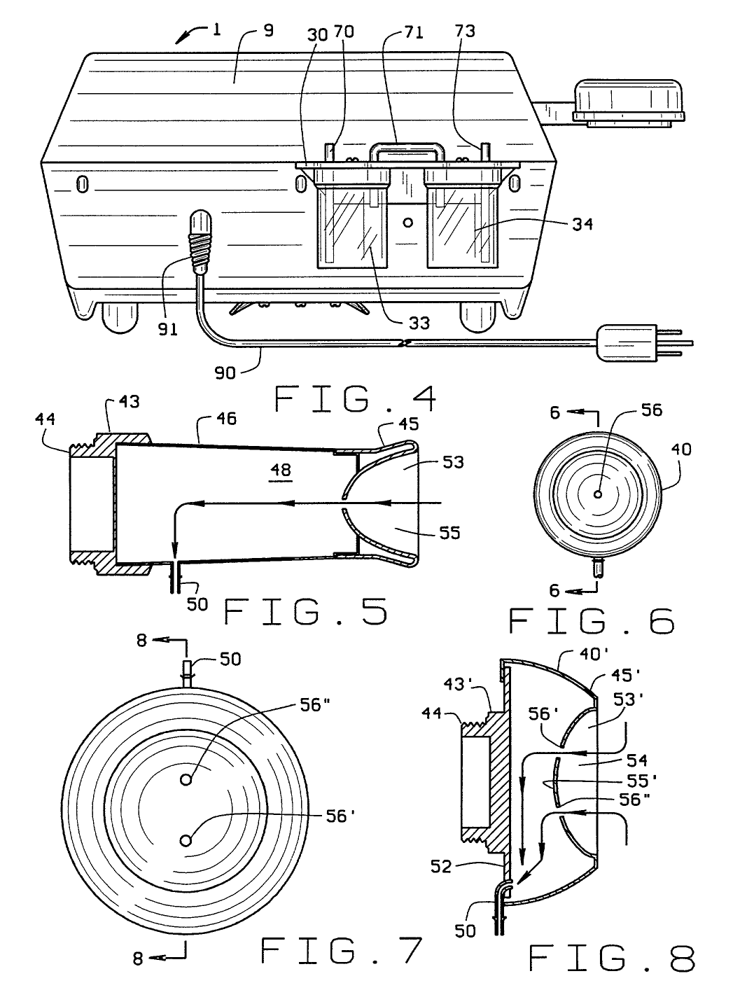

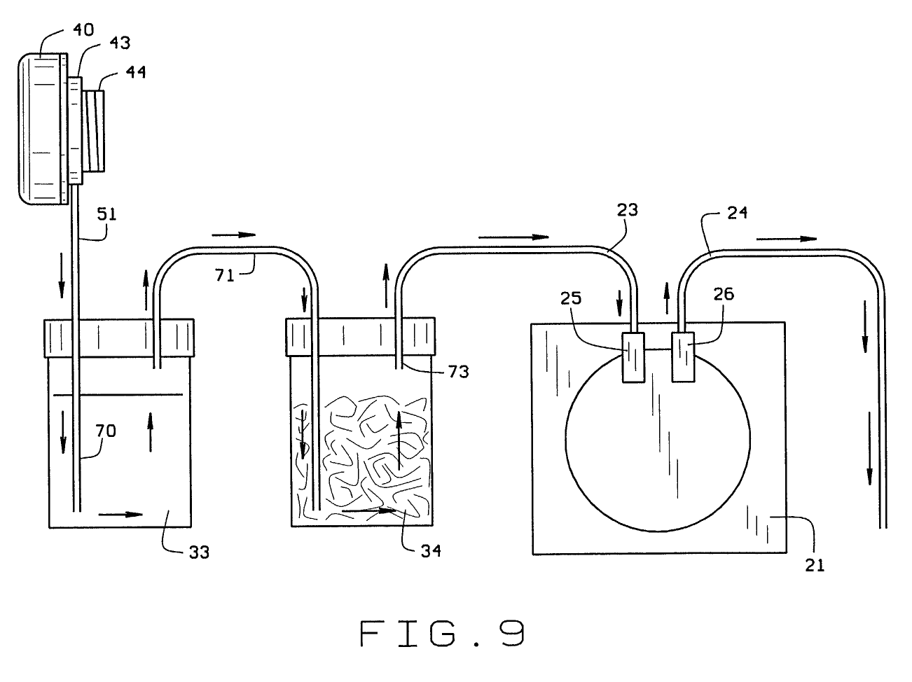

Referring more specifically now to FIGS. 5 and 6, a base area 43 of applicator 40 has a threaded first end 44 and a second end 45, interconnected by a body part 46. Body part 46 is an elongated, cylindrical structure defining an axial passage 48, closed at its respective ends by the base area 43 and the massage tip 53. The threaded end 44 is intended to permit the mounting of the applicator 40 to the massage head 15 in a conventional manner. The body 46 has a connection tube 50 formed in it, which communicates with the passage 48. The connection tube 50 is sized to permit the ready connection and disconnection of a suction line 51. The end 45 of applicator 40 has the massage tip 53 associated with it. The massage tip 53 is constructed from relatively soft, pliable material and is designed to form an axially inwardly extending cavity 55 along the end 45 of the applicator 40. The cavity 55 has an opening 56 formed in it, which permits the cavity 55 to communicate with the connection tube 50 through the passage 48 of the body 46, as diagramatically indicated in FIG. 6.

FIGS. 7 and 8 represent the second illustrative body of the applicator 40. Like primed numerals are utilized where appropriate.

Again, an applicator 40′ shown in FIG. 8 includes a base 43′ having a threaded end 44′ and a massage end 45′. The threaded end 44′ of the base 43′ permits the applicator 40′ to be easily attached to and removed from the massage head 15.

The end 45′ of the applicator 40′ also is constructed from a relatively soft, pliable material. The end 45′ has an axially inwardly extending cavity 55′ formed in it, defined by a concave wall 54. The wall 54 has a pair of openings 56′ and 56′′ formed in it, which permit the cavity 55′ to communicate with the tube 50, as diagramatically indicated in FIG. 8. The tube 50 is the embodiment of FIG. 8 in integrally formed with an end wall 52 formed along the base area 53. As will be appreciated by those skilled in the art, size shape and design of the applicators 40 may vary in other embodiments of my invention. Each of the applicators 40 have in common the ability to transfer an oscillatory or vibratory force to a portion of the body, the body portion skin being drawn inwardly of the cavities 55, 55′ formed along the massage tip 53, 53′ of the respective applicators.

The vacuum suction line 51 is connected between the tube 50, and the vial or filter 33. In the embodiment illustrated, the vacuum line 51 runs along the transmission line 19 and is attached to the transmission line by any convenient method. Conventional tie devices may be used, for example, if desired.

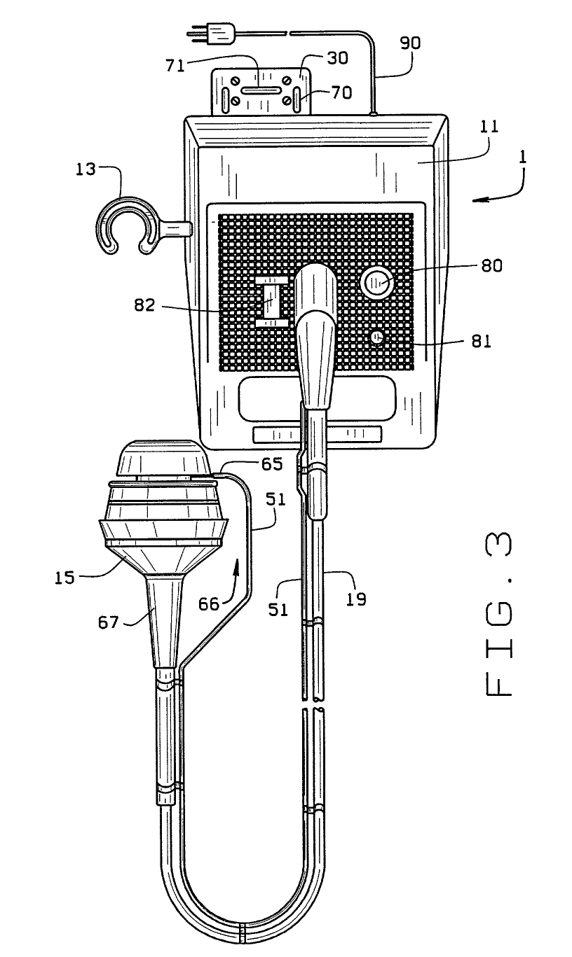

Referring now to FIG. 3, it may be observed that the line 51 has a bowed section 60 from in it, which terminates along quick connect end 65. The quick connect 65 is relatively simple to insert onto the tube 50 of the respective applicators. The bowed section 60 defines a clearance area for a handle part 67 of the massage head 15, permitting a user to hold the head 15 in a convenient manner without interfering with line 51 operation. The line 51 extends back to and through the housing 3, to an input 70 of the vial 33. The vial 33 has a cross over line 71 connection to the vial 33 a second vial 34. The vial 34 has a output 73 connected to the suction line 23 of the pump 21.

The top wall 11 of the housing 3 has the controls for the massage apparatus 1 associated with it. The controls include a speed control knob 80, an indicator lamp 81 and a vacuum pump switch 82. A power cord 90 includes a suitable strain relief 91 and connects the pump and motor to a source of electrical energy, through the knob 80 and switch 82, which in part define a control system for the apparatus 1.

The operation of the apparatus 1 is relatively simple to understand. The control 80 has an off position and a plurality of motor speed positions which may be adjusted by the user. Operation of the apparatus 1 in this manner is generally similar to that described in the above referenced patents '226, '334 and '806 in that a vibratory directional stroking motion is imparted through the transmission line 19 to the massage head 15. One of a variety of suitable applicators (40, 40′) is attached to the massage head 15 and the quick connect 65 is attached to the tube 50 connection. It is a feature of the invention that the massage apparatus can provide normal massage, and with activation of the pump 21, can be used to draw skin into the cavities 53, 53′ while simultaneously providing a mechanical vibration or oscillation on the skin. The different shapes and diameters of applicators are used to apply therapy to different body locations.

As will be appreciated by those skilled in the art, a lotion is frequently used to help glide the applicator across the skin's surface. With the vacuum pump actuated, the vacuum line will draw excess lotion through the applicator and the line 51 into the vial 33. The vial 33 is intended to capture the lotion while the vial 34 captures dust and lint that can accumulate in the vacuum chamber of the pump. The vials, as described above, are removable for easy cleaning. The vial filtering also helps reduce contamination and prolong the life of the rubber diaphragm in the pump.

During treatment, the skin surface at the location of the applicator is drawn into the concave section of the applicator, where the skin is also slightly compressed. The suction and combination with compression and vibration helps break up the fat clusters, elongates fibrous spans and increases circulation of the target area, increasing waste by-products that are removed by the body's natural waste removal system. As indicated, both the suction and vibratory function can be used independently or in combination. The applicators are attached to head 15 in the manner indicated and can be easily removed.

The forgoing detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention.

Numerous variations, within the scope of the appended claims, will be apparent to those skilled in the art in light of the foregoing description and accompanying drawings. Merely by way of example, the applicator designs can vary in other embodiments of the invention. While the preferred embodiment has what has been described as a claim shell construction, other design silhouettes may be employed. Various features of the invention which were designed for aesthetic appearances may be changes in other embodiments of the invention. These variations are merely illustrative.

Having thus described the invention, what is claimed and described to be secured by Letters Patent is:

1. A massage apparatus for massaging a human body, comprising:
a housing;
a motor associated with said housing;
a drive cable operatively connected to said motor;
a massage head driven by said motor through said cable, said motor imparting mechanical oscillations to said massage head;
an applicator mounted to said massage head for transferring the mechanical oscillations to the body, said applicator head further having a cavity formed in it for permitting skin to be drawn inwardly of it;
a vacuum pump associated with said housing; and
a connection between said vacuum pump and one of said head and said applicator to impart at least a partial vacuum in the cavity of the applicator so that placement of the head on a human body results in the application of a force combination of mechanical oscillation and suction.

2. A massage apparatus of claim 1 further including a speed control associated with said housing for controlling the speed of the motor.

3. The massage apparatus of claim 1 further including at least one collection vile operatively associated with the vacuum line for removing contaminants in the vacuum line.

4. The apparatus of claim 3 further including a second vile for collecting air born containment's operatively associated in said vacuum line.

5. The apparatus of claim 4 wherein said valves are removably mounted to the apparatus.

6. The apparatus of claim 1 further including a control device to permit suction and vibration to be used independently of one another.

7. The apparatus of claim 6 wherein said applicator is removably mounted to said massage head.

8. The apparatus of claim 7 wherein said vacuum connection is carried by the power cable.

9. The apparatus of claim 8 wherein said vacuum connection is attached as an applicator by quick connect device.

10. The method of treating the human body to break up fat clusters and stretch fibrous tissue comprising:
applying vibratory force to the body through a massage apparatus;
applying a suction force selectively simultaneously with a vibratory force, the suction force drawing and stretching fibrous tissue in combination with the vibratory force to raise the skin and bring encapsulated fluids to the surface of the body.

11. The method of claim 10 further including the step of applying lotion to the body.

12. The method of claim 11 further including the step of removing access lotion through the massage apparatus.

13. The method of claim 12 wherein the vibratory force and section are selectively applicable alone or in combination with one another.

14. A method of claim 14 wherein the vibratory force is adjustable.

15. A therapy massage device comprising:
a housing;
a motor mounted to the housing;
a vacuum pump mounted to the housing;
a drive cable operatively connected to the motor;
a massage head operatively drive by the cable;
an applicator head mounted to the massage head;
a vacuum line connected between the applicator head and the vacuum pump; and
a control system mounted to the housing which is selectively operated to provide suction and vibration to the body through the applicator head.

16. The device of claim 15 wherein said control system includes a control for varying the speed of the motor.

17. The device of claim 16 further including at least one filter operatively associated with the vacuum line 51.

18. The device of claim 17 wherein said filter is removably mounted from the device.

19. The device of claim 18 further including a second filter operatively associated with the vacuum line.

20. The device of claim 19 wherein said first and second filters are replaceable.
